(19) United States
(12) Patent Application Publication
(10) Pub. No.: US 2003/0098844 A1
(43) Pub. Date: May 29, 2003

(54) Magnetic resonance imaging compatible response device

(76) Inventor: Ivan Melnyk, Coquitlam (CA)

Correspondence Address: Ivan Melnyk, 604 Cottonwood Ave, Coquitlam, BC, V3J 2S4, CA

(21) Appl. No.: 09/995,708

(22) Filed: Nov. 29, 2001

(51) Int. Cl. G09G 5/00

(52) U.S. Cl. 345/156

(57) ABSTRACT

The invention is a response device to be used in functional magnetic resonance imaging (MRI) procedures. The device consists of keypads with fiber optic push button switches connected with fiber optic cables to an electronic unit for the illumination of the switches and the detection of depression events. The bodies of the keypads have a plurality of openings; therefore, the switches can be positioned in different locations on the keypad to be ergonomically activated with the patient's fingers. The switches can also be located in a symmetrical arrangement allowing them to be pressed with a knob in sequence for performing joystick functions.

### REFERENCES CITED

U.S. Patent Documents

U.S. PATENT DOCUMENTS

| Patent | Issued | Inventor(s) | Title | Class |
|---|---|---|---|---|
| 3886544 | May 1975 | Narodny | Keyboard using optical switching | 340/365 |
| 4315147 | February 1982 | Harmer | Photoelectric witch with visible signal | 250/227 |
| 4459022 | July 1984 | Morey | Fiber optic angular sensor | 356/152 |
| 5409074 | April 1995 | Wilson, et al. | Motorized vehicle with fiber-optic | 180/6.5 |
| | | | joystick controller | |
| 5411023 | May 1995 | Morris, et al. | Optical sensor system | 128/633 |
| 5432544 | July 1995 | Ziarati | Magnet room display of MRI and | 348/61 |
| | | | ultrasound images | |
| 5434756 | July 1995 | Hsu, et al. | Distributed lighting system with fiber | 362/32 |
| | | | optic control | |
| 5621207 | April 1997 | O'Mara | Optical joystick using a plurality of | 250/221 |
| | | | multiplexed photoemitters and a | |
| | | | corresponding photodetector | |
| 5627902 | May 1997 | Ziarati | Magnetic resonance imaging | 381/187 |
| | | | compatible audio headset | |
| 5733247 | March 1998 | Fallon | MR compatible patient monitor | 600/410 |
| 6052614 | April 2000 | Morris, et al. | Electrocardiograph sensor and sensor | 600/509 |
| | | | control system for use with magnetic | |
| | | | resonance imaging machines | |
| 6222179 | April 2001 | Mikan | Fiber optic control having joystick | 250/221 |
| 6246047 | June 2001 | Mikan. | Fiber optic control with joystick | 250/221 |

FOREIGH PATENT DOCUMENTS

| | | | | |
|---|---|---|---|---|
| 2230662 | February 1998 | Canadian Patent | Optical fiber sensor system for electric | A61B 5/055 |
| | | Office | field environments | |
| 01/19427 | March 2001 | WIPO | Distributed architecture for apparatus | A61M |
| | | | used in a high magnetic field and/or RF | |
| | | | environment | |

### OTHER PUBLICATIONS

Brochure “LUMItouch Response System”, Lightwave Medical Industries Ltd, Burnaby, BC, Canada, 2001.

### BACKGROUND OF THE INVENTION

1. Field of the Invention

This invention relates to medical accessory equipment that is used in strong electromagnetic fields. More particularly, the present invention relates to response devices that are used in functional magnetic resonance imaging (MRI) procedures. The invention may be used in similar environments, such as magnetoencephalography (MEG) and electroencephalography (EEG).

2. State of the Art

Functional MRI scanning is a relatively new medical approach being extensively used in the medical community. This procedure offers numerous advantages over regular MRI scanning because it allows doctors to see the brain activities of the patients by asking them to react to certain signals and by taking the entire MRI picture at the same time. The stimuli signals are usually visual or audio signals coming through the communication window between the MRI scanning room and the control room where the MRI specialist controls the procedure. The patient lies inside the MRI scanner; he or she is asked to react to stimuli signals by performing simple actions, such as moving the fingers or hands. The action is controlled by a response device that determines the time interval between the stimulus and the patient reaction.

The response device like any other additional equipment inserted into an MRI scanner must be very carefully shielded in order to avoid interference with the weak signals that the MRI scanner is taking from the patient's brain. This task is very challenging because the MRI scanner provides a very strong magnetic field ranging from 0.5 Tesla to 5.0 Tesla. The strength of the magnetic field is constantly being increased as more advanced superconductive magnets are developed because a higher magnetic field offers better spatial resolution for the MRI scanner. Shielding has two major drawbacks: first, it increases the size of the equipment making it bulky and unsuitable for the limited space under the magnet and second, it increases the cost of functional MRI procedure in general. There are known designs of the response devices based on fiber optic technology entirely free from metals (thus, it is intrinsically non-ferrous). For instance, Canadian patent application No. 223062 discloses a fiber optic sensor system for electrical field environments that consists of a keypad with up to five fiber optic switches on it, a fiber optic cable connected to the switches, and electronic circuitry that provides illumination of the switches and detects when switches are pressed. This response system has been produced by Lightwave Medical Industries Ltd. under the trade name Lumitouch™ which is provided here as a reference.

While the foregoing design discloses a fiber optic response system that is compatible with MRI, the connection between switches and the keypad is shown as mostly diagrammatic in nature, with specific details largely omitted. In addition, the foregoing design does not offer flexibility for the manufacturer and the customer because each switch must be placed in an exact location on the keypad. The manufacturer must provide an individual keypad for the left and right hand as well as for the different number of switches required by each customer. Such customization increases the cost of the product. Also, it is desirable to have the distance between the keys changeable if the patient has smaller hand (for example, a child). Further, there is a need for a response system that will react to a rotating movement of the hand (joystick). The response device described above does not provide that.

Such shortcomings in the prior art where the design does not allow displacing the switches on the keypad are obviated by the present invention. One object of the invention is to provide an improved response system that will offer flexibility in the location of the fiber optic switches on the keypad, including the possibility of changing the number of switches and distances between them.

Another object of the invention is to provide a response system that will react to angular movement of the patient hand (using an MRI compatible joystick).

A further object of the invention is to provide an improved fiber optic system for MRI applications as set forth, wherein less universal parts must be manufactured, thereby reducing manufacturing cost, simplifying assembly, and improving reliability.

Other features and advantages will hereinafter appear.

In accomplishing the above objects, the invention provides an MRI compatible fiber optic response system that includes one or two keypads with optical switches on it, an electronic unit, and a fiber optic cable connecting the keypad to the electronic unit. The keypad has a number of holes on the front, left, and right sides for positioning the switches; the holes are sufficiently large to install switches; the holes are located quite densely, so switches can be installed in a variety of locations on the keypad. Each switch is made as a module having a base, an actuator, a shutter or a mirror, a key cap, and illuminating/receiving optical fibers. The optical fibers are combined in a cable that is connected to the electronic unit. The unit includes light sources and photodetectors, and a microcontroller for signal processing and communication with external devices. The switches can be positioned in a square or circular pattern; therefore, the joystick function can be realized by pressing them in sequence with a knob.

### BRIEF DESCRIPTION OF THE DRAWINGS

FIG. 1A is a schematic illustration of the prior art, a response keypad with two switches on it;

FIG. 1B is the same illustration as FIG. 1A for four switches of right-hand keypad;

FIG. 2 is a three-dimensional view of the keypad of the response device of the invention;

FIG. 3 is a sectional view of the fiber optic switch working in transmittive mode;

FIG. 4 is a three-dimensional view of the switch of FIG. 3 with a snapping feature on the top of the base and without a key cup on the switch;

FIG. 5 is a three-dimensional view of the switch of FIG. 3 with a snapping feature on the bottom of the base;

FIG. 6 is a schematic view of the right-hand keypad of FIG. 2 with five switches on it;

FIG. 7 is a schematic view of the keypad with an arrangement of four switches along the square;

FIG. 8 is a schematic view of the keypad with the circular arrangement of eight switches;

FIG. 9 is an illustration of the possible directions achievable by activating the switches of FIG. 7;

FIG. 10 is an illustration of the possible directions achievable by activating the switches of FIG. 8;

FIG. 11 is a schematic view of the keypad of FIG. 7 with a knob;

FIG. 12 is a sectional view of the knob and switches of FIG. 11;

FIG. 13 is a sectional view of the knob with a start button and a movable switch;

FIG. 14A is a sectional view of the fiber optic switch working in reflective mode;

FIG. 14B is a view of the depressed switch of FIG. 14A;

FIG. 15 is a view of the depressed switch of FIG. 14A with a bifurcated cable;

FIG. 16 is a general schematic view of the MRI compatible response device of the invention;

FIG. 17 is an example of the front panel of the electronic unit of the response device;

FIG. 18 is a general electronic schematic of the response device.

### DETAILED DESCRIPTION OF THE INVENTION

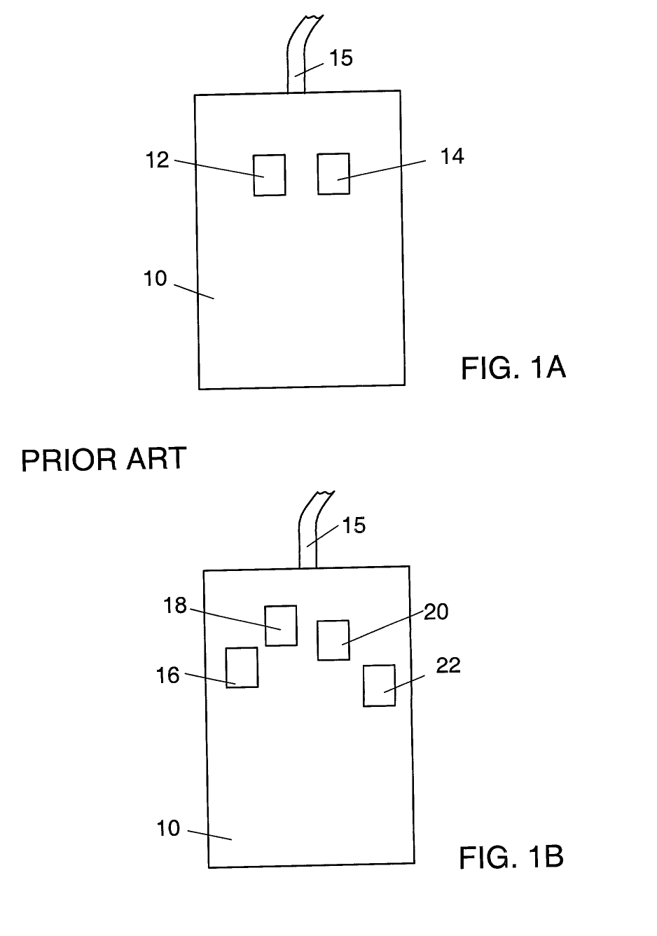

Referring first to FIG. 1A and FIG. 1B, the prior art is disclosed. A keypad (10) comprises a box made of non-ferrous material, preferable plastics, the box has optical switches in it with key cups (12) and (14) facing out to be pressed by the forefinger and the middle finger, respectively. An optical cable (15) connects the switches with an electronic circuitry (not shown) where the light source, photodetectors, and signal processing means are located. The typical length of the optical cable exceeds 10 m in order to keep electronics outside the MRI scanner room and avoid possible interference with the magnet. The keypad can have four switches to be activated by four fingers; FIG. 1B shows an example of the location of four switches for the right hand keypad. The manufacturer is creating a more convenient and ergonomic design by displacing the switches (16), (18), (20), and (22) at locations that are close to finger ends.

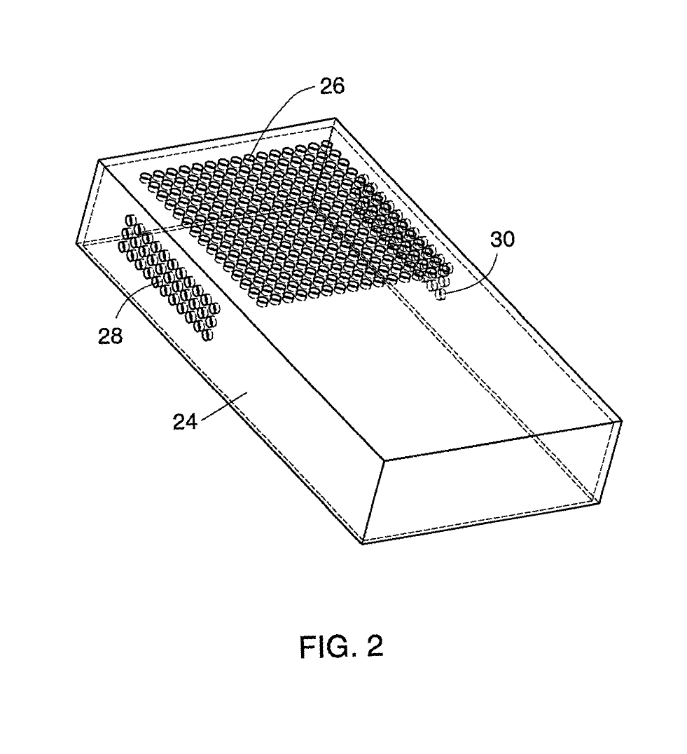

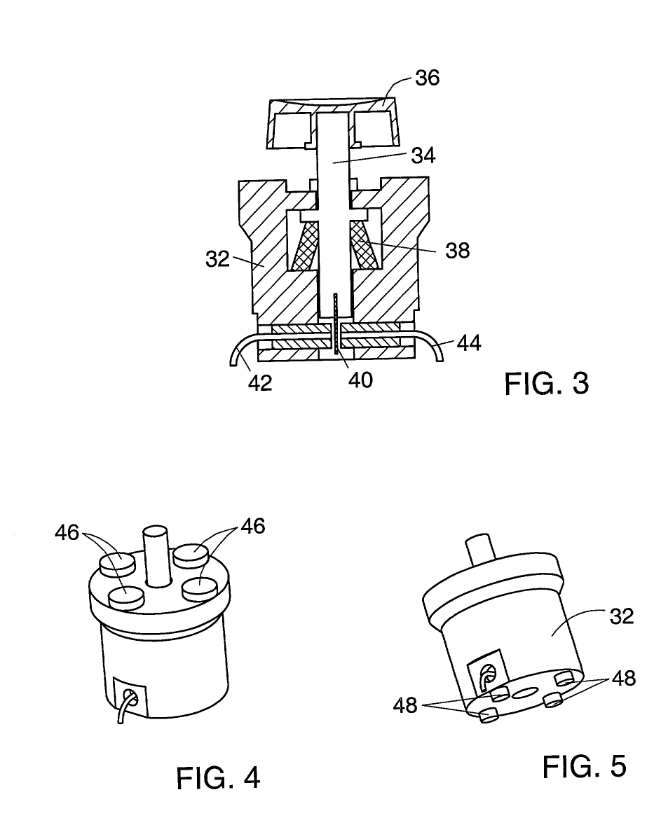

According to the present invention, the keypad (24) has a plurality of identical holes (26), (28), and (30) on the front, left, and right sides, respectively, as shown in FIG. 2. The preferred shape of the holes is square or round. The holes serve for mounting fiber optic switches. The switches may be made in a variety of ways. As preferred, the modular design of the switches is described below. FIG. 3 shows an example of the switch that works in a transmittive mode. The switch consists of a base (32) and an actuator (34) that can move in the base when a force is applied to a key cup (36) that deforms a rubber spring (38). A shutter (40) blocks the light coming from an illuminating fiber (42) to a detecting fiber (44) when the spring bounces the actuator back, and it allows passing the light to the detecting fiber when the key cup is pressed. The switch can work in opposite mode, such that it transmits the light in the open condition and blocks the light after being pressed. Preferably, the switch operates in a direct mode. All parts of the switch are made of non-ferrous materials, preferably plastic. The fibers are preferably plastic optical fibers due to their lower cost and simple termination; however, regular multimode glass fibers may be used. The core diameter of the fibers ranges from 0.1 to 3.0 mm, preferably from 0.2 to 1.0 mm. The switch is mounted in the keypad from inside by inserting the actuator into one of the holes in the keypad (if the key cup is used, it must be assembled to the switch afterward). Holes around the insertion hole can be used for connecting the switch to the keypad. Preferably, this connection is done by snapping the base of the switch to the keypad. The snapping can be realized by a variety of means, such as, for example, by pins (46) shown in FIG. 4; the pins exactly fit to four holes in the keypad. A snapping feature, such pins (48) can be located at the bottom of the base (32) as is shown in FIG. 5. The switch is snapped to the floor of the keypad. This design will allow achieving a more reliable connection of the switch to the keypad.

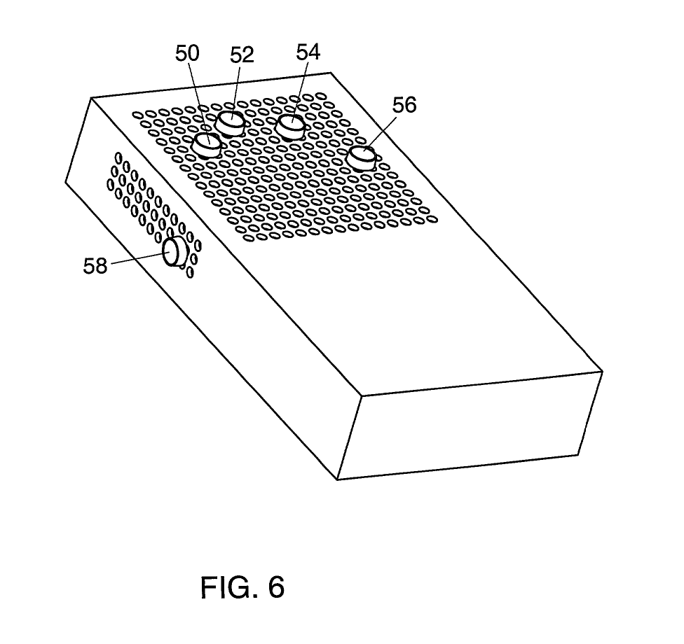

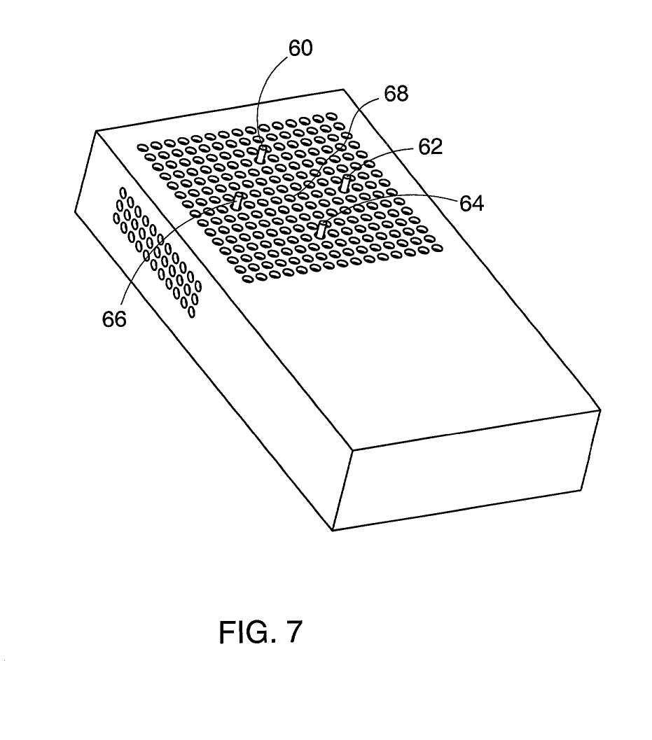

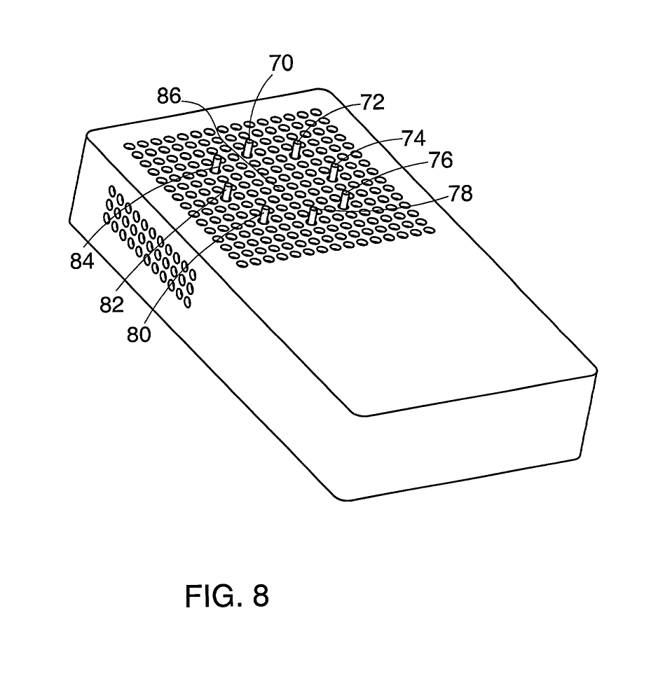

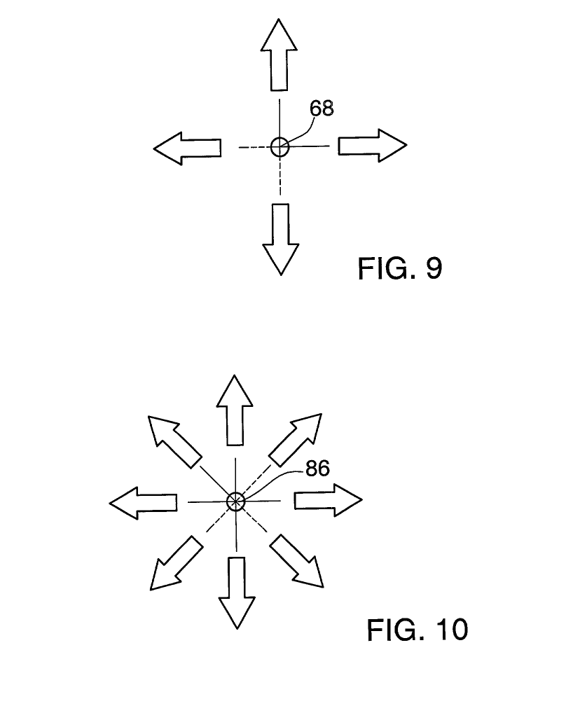

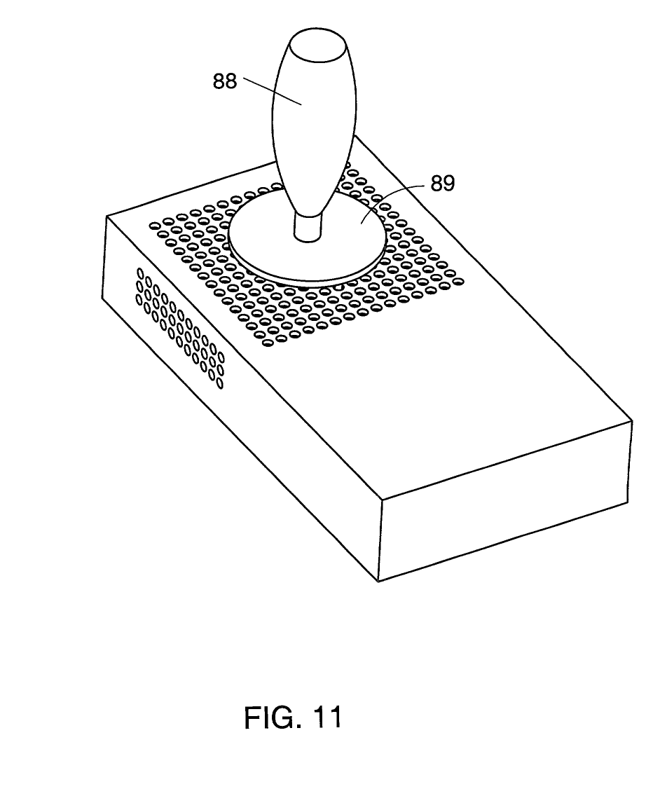

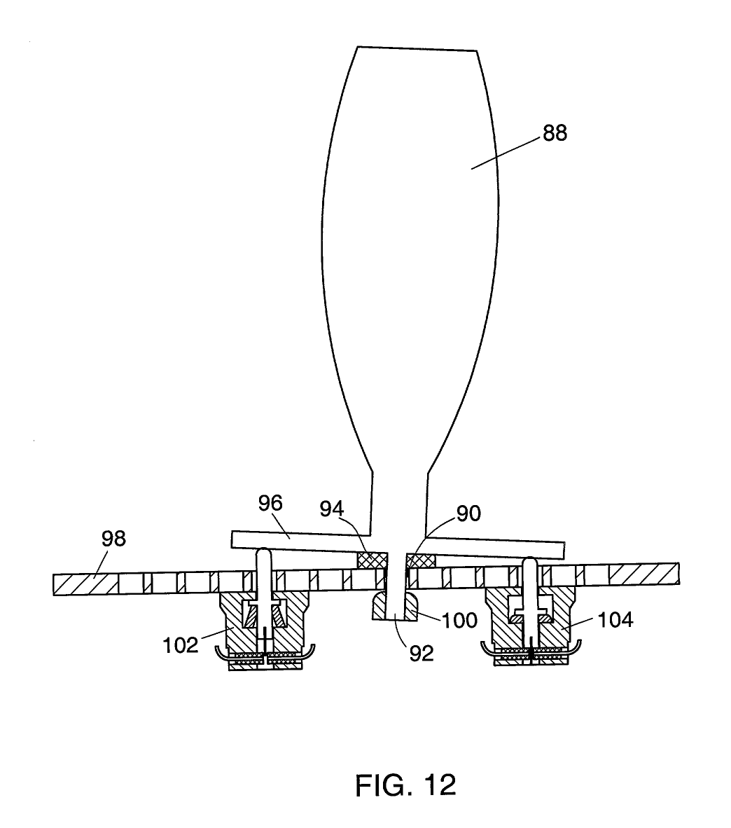

FIG. 6 shows an example of the assembled right-hand keypad with four switches (50), (52), (54), and (56) on the front to be pressed by the forefinger, the middle finger, the fourth finger, and the little finger, respectively, and one switch (58) on the right side of the keypad for activation with the thumb. The switches can be located in a square arrangement, such as shown in FIG. 7 where four actuators, (60), (62), (64), and (66) are mounted equidistantly from the central hole (68). Any other symmetrical arrangement of the switches can be achieved. For instance, FIG. 8 discloses a circular arrangement where eight actuators (70), (72), (74), (76), (78), (80), (82), and (84) are located around the central hole (86). If switches are sequentially activated, the square and circular arrangements allow the recording of movements along four or eight directions as shown in FIG. 9 and FIG. 10, respectively. Such function is similar to one that is realized in joysticks. The sequencing activation of the switches may be achieved by rotating a knob (88) with a flange (89) as is disclosed in FIG. 11. The knob is mounted in the central hole (90) by insertion of its lower portion (92) in the hole as schematically shown in FIG. 12. The knob is kept in a vertical position by means of an elastic element (94) that is located between the flange (96) and a front surface (98) of the keypad. The elastic element can be formed as a ring made of rubber, silicone, or similar materials. The knob is protected by a ring (100) from being removed from the keypad; the ring is snapped to the lower portion (92) of the knob. The diameters of the hole (90) and the lower portion (92) as well as the thickness of the elastic element (94) are chosen from the maximum angular displacement of the knob. In the position shown in FIG. 12, the switch (102) is released while switch (104) is depressed with the flange (96). The knob can be connected to the keypad by a variety of means, such as by the spherical joints that are commonly used in joysticks.

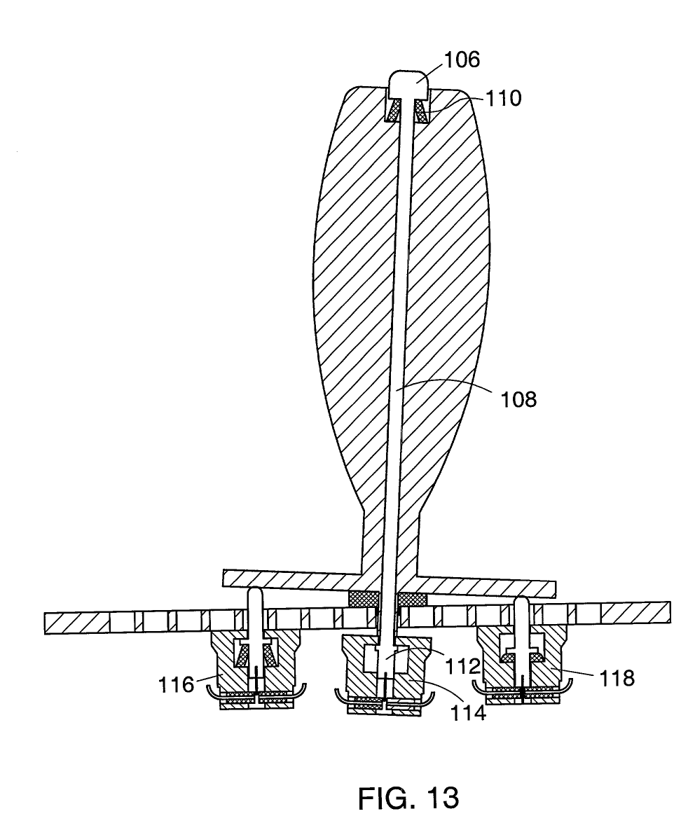

Such connections provide higher accuracy; however, they are more complicated as opposed to the through-hole connection described above. The knob can be equipped with a start button (106) as is shown in FIG. 13. The start button is preferably located on the top of the knob in order to be activated with a thumb. The start button is connected with an extended actuator (108) that is spring-loaded by an elastic spring (110). A bottom part (112) of the extended actuator mates with a movable fiber optic switch (114); this switch can be identical to switches (116) and (118) that are used for control of the angular movement.

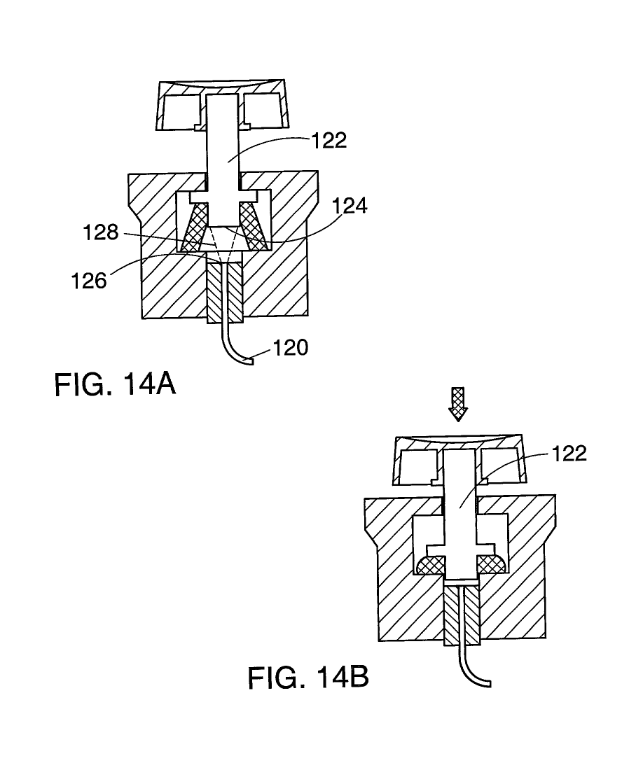

Fiber optic switches, such as the one shown in FIG. 3, can work in reflective mode when the shutter is replaced with a mirror. This design combines the illuminating fiber and the receiving fiber into one because the light bounces back to the fiber after being reflected from the mirror. The lateral movement of the mirror toward the fiber is not practical because it requires precise positioning of the mirror. The axial movement, when the mirror moves toward the fiber, would be preferable. FIG. 14A shows an example of the switch based on the axial design. The fiber (120) is positioned coaxially with the actuator (122) that has a reflective surface (124) on the end. The switch operates as a typical proximity switch; when the distance between the fiber end (126) and the reflective surface (124) is large, the intensity of the light that is reflected back and enters the fiber (120) is low due to the light divergence from the fiber end. The light leaves the fiber within a cone (128) that is determined by the numerical aperture of the fiber. Many inexpensive multimode fibers, particularly plastic optical fibers, have high numerical apertures and, thus, the light spreads from the fiber end within a cone of ±30 degrees and more. FIG. 14B shows the same switch when the actuator (122) is depressed. The reflective surface is in close proximity to the fiber end; therefore, the amount of light entering the fiber is high; consequently, the excess of light may trigger the electronics.

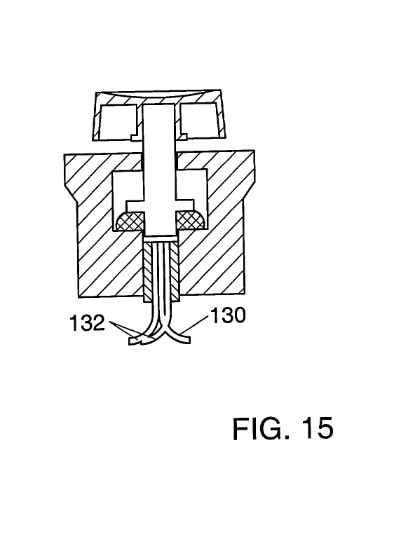

The single fiber axial design of the switch requires splitting of the light that is focused from the light source and is received by the detector. Splitting adds complexity to the system and consequently increases the cost of the device. The light scattering and back-reflection are other drawbacks of the single fiber design due to the high ambient illumination of the detector. These drawbacks are reduced by using a bifurcated fiber optic cable. FIG. 15 discloses an example of the switch with a bifurcated optical cable. In such a cable, the illuminating fiber (130) is located in the center of the cable and the receiving fibers (132) are coaxially mounted around the central fiber.

The number of fibers in the cable may be reduced by optical multiplexing, which is achieved by making the shutter (40) in FIG. 3, or the reflective surface (124) in FIG. 14A, as narrow-band optical filters. The filter in each switch can select a certain spectral band from the total spectrum produced by the light source. The photodectors analyze the intensity of each spectral component received and determine which switch has been depressed. Each keypad, left-hand and right-hand, can be connected to the electronic unit with only one fiber, or both keypads can work with the only one fiber because the maximum capacity of the system (10 channels, five for each keypad) can be achieved using relatively low-cost interference filters and dielectric mirrors.

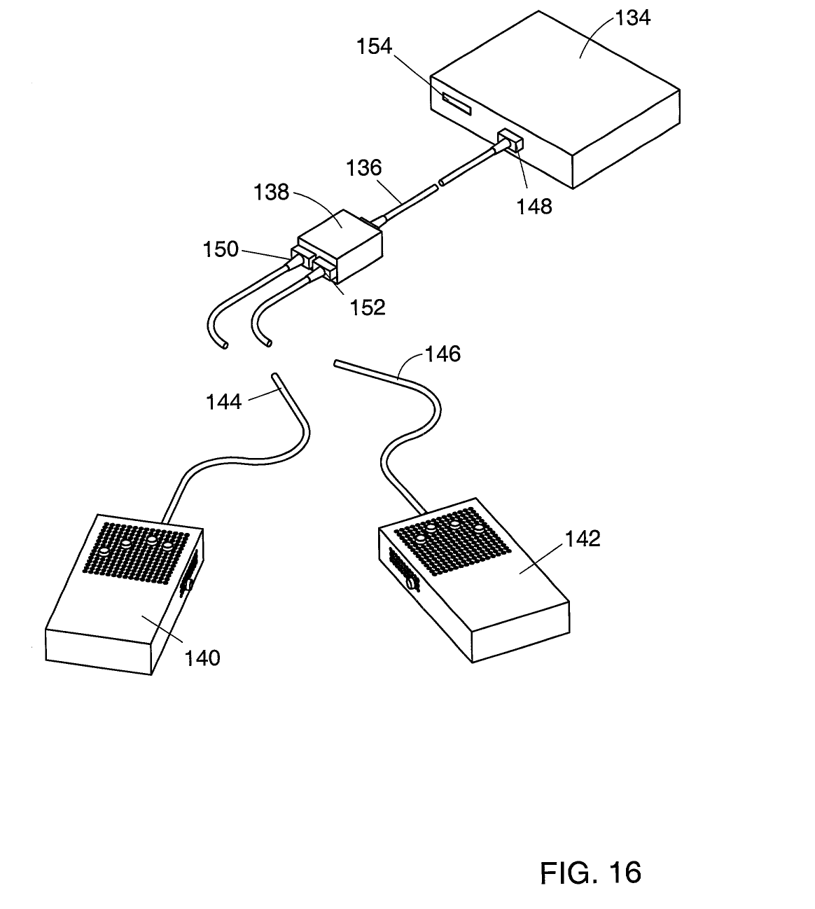

FIG. 16 discloses a general schematic view of the device according to the present invention. The device includes an electronic unit (134) that is connected through a main fiber optic cable (136) to a Y-box (138). The Y-box is connected to a left-hand (140) and right-hand (142) keypads by short fiber optic cables (144) and (146), respectively. Depending on the configuration of the device, only one keypad can be connected to the Y-box, or two more keypads with joysticks can be connected to the Y-box. The main cable is connected to the electronic unit via a connector (148); preferably, the connection between the main cable and the Y-box is permanent. The main cable is long enough to remove the electronic unit from the MRI room; the preferred length of the cable is from 7 to 20 m. All components of the device, except the electronic unit (134) and connector (148) are made of ferrous-free materials; preferably, they are plastic components. A connection between the Y-box and the short cables (144) and (146), preferably, is nonpermanent; it is provided by connectors (150) and (152), respectively. The short optical cables are approximately 2 m long based on a convenient location of the Y-box on the bed under the magnet where the patient is lying. Preferably, the connection between the short cables and the keypads are permanent in order to reduce optical losses in the connection and to achieve better reliability. The lateral dimensions of the connector (148) must allow passing of the connector through the magnetic screen around the MRI room; the maximum aperture in the screen is allowed to be not more than 1 inch or about 25 mm. The electronic unit has a connector (154) for connection to the external devices that may include personal computers, regular hardware that is used in psychiatry, and communication means for synchronization of the device with the MRI scanner.

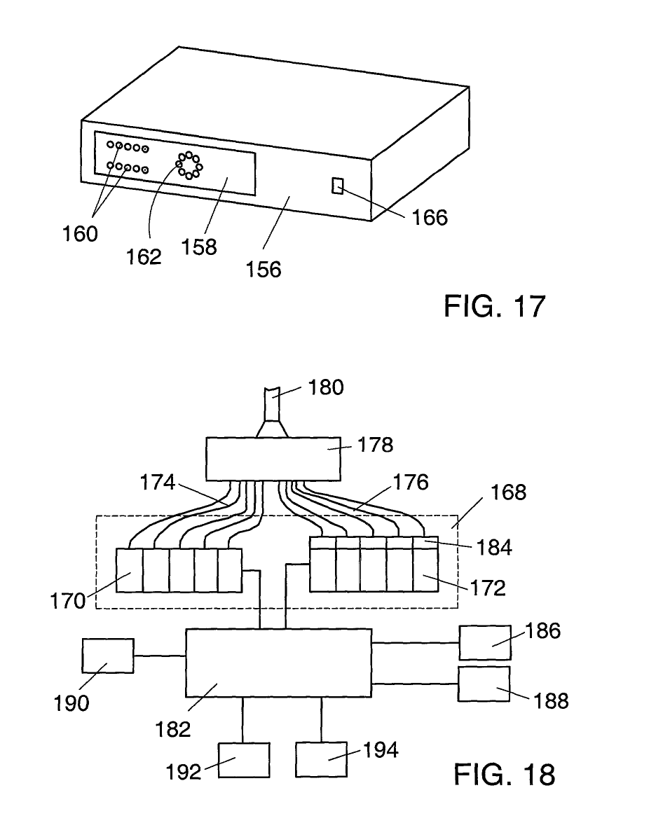

A schematic external view of the electronic unit is shown in FIG. 17. The unit may include a front panel (156) with a screen (158) on it. The screen may have indicators (160); the preferred indicators are up to 10 light emitting diodes (LED) signaling the status of each switch on the keypads. A circular indicator (162) can show which of the switches is activated each time the knob of the joystick is rotated. An additional indicator (166) may show the status of the device, operating mode (push-button key or joystick), or preliminary results, such as time response, rotation speed, and amplitude. FIG. 18 shows a schematic of the internal content of the electronic unit in general. The electronics include a photoelectric module (168) comprising a plurality of light sources (170) and a plurality of photodetectors (172). The light sources and photodetectors are coupled to illuminating fibers (174) and receiving fibers (176), respectively. Illuminating and receiving fibers are terminated at their ends in the connector (178) that provides fiber-to-fiber connection between the photoelectric module and the main optical cable (180). The light sources are powered and controlled through a microcontroller (182); signals from photodetectors are processed by the same microcontroller. The photodetectors may have filters and couplers (184) that provide optical signal demultiplexing in case two or more signals are sent through one fiber (i.e., fiber optic switches work in reflective mode). Preferably, the light sources are LEDs, in particular, green LEDs when acrylic optical fibers are used. The photodectors are, preferably, discrete Si-photodiodes, phototransistors, or linear photodectors, such as CCD arrays. An input (186) provides synchronization signals from the MRI scanner preventing the interference of the servicing MRI electronics with the response device. An input (188) may be associated with the optical or sound stimuli that are provided during psychological testing; this association can be realized as a synchronization between the stimuli generator and the response device. The microcontroller determines the response time between the stimuli signals and the signals coming from the photodetectors; it also determines the time between pulses coming in sequences during rotation of the joystick and thus calculates the rotation speed. The device is powered by a power supply (190) that can be a regular 6V, 9V, 12V, or 18V DC converter depending on the output signals required. The output (192) of the device can provide signals in a variety of formats, such as TTL, RS232, USB, and others. In addition, the output signals can be processed to be compatible with the software packages that are commonly used in psychiatry. The microcontroller is connected to an indicator (194) where the current status of the switches as well as the preliminary results are displayed.

It is understood that above-described embodiments are merely illustrative of the possible specific embodiments which may represent principles of the present invention. Other arrangements may readily be devised in accordance with these principles by those skilled in the art without departing from the scope and spirit of the invention.

What is claimed is:

1. A response device compatible with a magnetic resonance imaging (MRI) apparatus and similar medical techniques associated with strong magnetic environments, the device comprising:
a keypad connected with a fiber optic cable to an electronic unit that includes photoelectric means for illuminating optical fibers in said fiber optic cable, photodetecting means for detecting the light coming from said keypad through said fiber optic cable, and signal processing means for processing signals from said photodetecting means, and communication with external devices;
fiber optic push button switches that are located in said keypad to be pressed by a patient who is undergoing a response test, each said fiber optic switch comprising:
a base and an actuator that can move in said base while being pushed at the depressing end;
a spring that keeps said actuator in a fixed position in said base when said actuator is not depressed;
an illuminating fiber that provides light to a shutter that is attached to another end of said actuator;
a receiving fiber that is located in said base coaxially with said illuminating fiber, said receiving and illuminating fibers providing a gap for sliding said shutter in it when said shutter moves in said base;
a body of said keypad represents a box with a plurality of holes in the front, left, and right sides for mounting of said fiber optic push button switches in different locations on the keypad.

2. The response device of claim 1 wherein each said fiber optic push button switch comprises:
a base and an actuator that can move in said base while being pushed at the depressing end;
a spring that keeps said actuator in a fixed position in said base when said actuator is not depressed;
an optical fiber that provides light to a reflective surface at another end of said actuator and collects light that is reflected from said reflective surface.

3. The response device of claim 1 wherein:
said base of said fiber optic push button switch has a snapping means on its top surface;
an internal surface of said box has a snapping means that mates with said snapping means of said base;
said fiber optic push button switch is mounted inside of said box by mating said snapping means on said base and said internal surface;
said depressing end of said actuator is facing out from an external surface of said box at a distance from 2 to 20 mm;
said depressing end of said actuator is inserted in one of said openings in said box;
said depressing end of said actuator can slide in an opening where it is inserted.

4. The response device of claim 1 wherein:
said base of said fiber optic push button switch has a snapping means on its bottom surface;
an internal surface of said box has a snapping means that mates with said snapping means of said base;
said fiber optic push button switch is mounted inside of said box by mating said snapping means on said base and said internal surface;
said depressing end of said actuator is facing out from an external surface of said box at a distance from 2 to 20 mm;
said depressing end of said actuator is inserted in one of said openings in said box;
said depressing end of said actuator can slide in an opening where it is inserted.

5. The response device of claim 1 wherein said fiber optic push button switches are located on said box in positions that provide ergonomic depressing of said switches with fingers.

6. The response device of claim 1 wherein two keypads are connected to said electronic unit, one keypad to be activated with the left hand and another keypad to be activated with the right hand.

7. The response device of claim 1 wherein said fiber optic push button switches are located on said box in positions that are equidistant from a central opening on a front side of said box.

8. The response device of claim 7 wherein said four fiber optic push button switches are located on said front side in a square arrangement.

9. The response device of claim 7 wherein said eight fiber optic push button switches are located on said front side in a circular arrangement.

10. The response device of claim 7 further comprising:
a knob that is inserted into said central opening;
said knob has a flange that can touch all said depressing ends of said fiber optic push button switches;
said knob can be tilted and rotated inside said central opening and said flange can press said depressing ends of said fiber optic push button.

11. The response device of claim 10 further comprising:
a handle with a start button on it;
said start button is connected to a movable fiber optic switch that is inside of said box and is attached to the end of said handle that is inserted into said central opening.

12. The response device of claim 10 further comprising:
an elastic ring that is located under said flange;
said ring holds said knob perpendicular to front side of said box if said knob is not tilted;
an insertion part of said knob has a fixing means that prevents said knob from being removed from said box when said knob is tilted and rotated.

13. The response device of claim 6 wherein:
said keypads are connected with peripheral fiber optic cables to a Y-box;
said Y-box is connected to said electronic unit with a main fiber optic cable.

14. The response device of claim 13 further comprising:
a third keypad with said knob in it;
said third keypad is connected with said peripheral fiber optic cable to said Y-box.

15. The response device of claim 14 wherein:
said main fiber optic cable has a length from 10 to 30 m;
said peripheral fiber optic cable has a length from 0.5 to 2.5 m.

16. The response device of claim 1 wherein:
said electronic unit has a plurality of light sources coupled to illuminating optical fibers of said main fiber optic cable;
said electronic unit has a plurality of photodectors coupled to receiving optical fibers of said main fiber optic cable;
said light sources and photodetectors are controlled by a microcontroller;
said microcontroller provides output signals that correspond to pressing events of said fiber optic push button switches.

17. The response device of claim 16 wherein said microcontroller provides output signals that are synchronized with external sound or visual stimuli that are provided to said patient.

18. The response device of claim 16 wherein said microcontroller provides output signals that are synchronized with signals from the MRI scanner.

19. The response device of claim 1 wherein said microcontroller provides an indication on a screen located on said electronic unit about which said fiber optic push button switches is depressed in each moment.

20. The response device of claim 1 wherein all parts, except said electronic unit, are made of non-ferrous materials.
